(19) United States
(12) Patent Application Publication
(10) Pub. No.: US 2006/0282576 A1
(43) Pub. Date: Dec. 14, 2006

(54) Computer peripheral converter

(75) Inventor: Han Hsu, Hsin-tien City (TW)

Correspondence Address: ANTHONY R. BARKUME, 20 GATEWAY LANE, MANORVILLE, NY, 11949, US

(73) Assignee: Omnidirectional Control Technology Inc.

(21) Appl. No.: 11/294,111

(22) Filed: Dec. 5, 2005

(30) Foreign Application Priority Data
May 24, 2005 (TW) 094208602

(51) Int. Cl. G06F 13/38

(52) U.S. Cl. 710/62

(57) ABSTRACT

A computer peripheral converter, which comprises: one PS2 connecting point, one USB connecting point and one external connecting point, and one CPU with a serial interface engine to convert the PS2 connecting point to the external connecting point and send out an external interface signal; and to convert to the USB connecting point to the external connecting point and send out an external interface signal.

### FIELD OF THE INVENTION

The present invention relates to a computer peripheral converter, which is used to switch PS2 peripherals and USB peripherals to PS2 output, connects with a computer or a PS2/USB interface, and makes several computers share the peripherals such as a mouse, a monitor, and a keyboard.

### BACKGROUND OF THE INVENTION

It is very popular that several computers connects with one monitor, one mouse, or one keyboard to share the same peripherals for equipment cost down purpose, for example, in the offices, factories, and laborites. FIG. 1 shows the application block diagram of a traditional keyboard/video/mouse switch (KVM), which comprises three computers 11, one KVM switch 12, one monitor 13, one mouse 14, and one keyboard 15. These three computers could be able to share the same peripherals (one monitor 13, one mouse 14, and one keyboard 15) by this KVM switch to cost down the peripheral equipments and save the space.

The KVM switch is very simple in the early stage because the interfaces of monitors, keyboards, and mice are using Mini Din connecters and PS2 connecters, respectively. That is, the PS2 ports of these multiple computers are able to connect with and share one PS2 peripheral (a PS2 keyboard or a PS2 mouse), and the monitor ports of these multiple computers are able to connect with and share one monitor. After the USB interface created, all peripherals and computers support this USB interface. Of course, KVM switch also support this standard.

The current KVM switch also can support the switching of USB interface, connect the USB ports of multiple computers with one USB peripheral (such as a USB keyboard or a USB mouse) and share it. Further more, this KVM switch is also able to connect the PS2 ports or USB ports of these multiple computers with one USB peripheral to share it.

However, the prices of PS2 hardware are quite so cheap, and there are so many PS2 keyboards and PS2 mice in the current market makes computers still support PS2 ports. So far, KVM switch supports PS2 peripherals to PS2 computers, PS2 peripherals to USB computers, and USB peripherals to USB computers, but without the total interconnection solution for USB/PS2 peripherals to USB/PS2 computers. That is, the end customers or sales of KVM switch have to consider the PS2 or USB peripheral interface to PS2 or USB computer very sincerely, which bother the end users and sales very much.

### BRIEF DESCRIPTION OF THE INVENTION

According to the present invention, a new, advanced, and practical computer peripheral converter is created to converter USB peripherals or PS2 peripherals to a PS2 computer, or converter to a PS2/USB interface. That is, this computer peripheral converter is able to support USB to PS2, USB to USB, PS2 to USB, and PS2 to PS2 between the peripherals and computers in four switching modes. End users will be able to use the KVM switch of the present invention very easily and never mention about the USB port or PS2 port that the computer supports, or the interfaces of keyboard and mouse are USB or PS2 standard.

For above purpose, the present invention is a computer peripheral converter, which comprises: one PS2 connecting point, one USB connecting point and one external connecting point, and one CPU with a serial interface engine to convert the PS2 connecting point to the external connecting point and send out an external interface signal; and to convert to the USB connecting point to the external connecting point and send out an external interface signal.

In accordance with one aspect of the present invention, the external connecting point of this computer peripheral converter also comprises two PS2 sockets for connecting with the keyboard PS2 port and the mouse PS2 port of a computer.

In accordance with one aspect of the present invention, the PS2 connecting point of this computer peripheral converter also comprises two PS2 sockets for connecting with one PS2 keyboard and one PS2 mouse.

In accordance with one aspect of the present invention, the USB connecting point of this computer peripheral converter also comprises two USB sockets for connecting with one USB keyboard and one USB mouse.

In accordance with one aspect of the present invention, the external connecting point of this computer peripheral converter connects with PS2/USB interface and to make one of the PS2 keyboard or USB keyboard, and one of the PS2 mouse or USB mouse could be able to control several computers.

In accordance with one aspect of the present invention, the several computers support PS2 ports or USB ports.

In accordance with one aspect of the present invention, the external interface signal could be a PS2, I2C, SPI (Serial Peripheral Interface), UART, or self-defined interface signal.

The present invention may best be understood through the following description with reference to the accompanying drawings, in which:

### BRIEF DESCRIPTION OF THE DRAWINGS

FIG. 1 shows the block diagram of the traditional keyboard/video/mouse (KVM) switch.

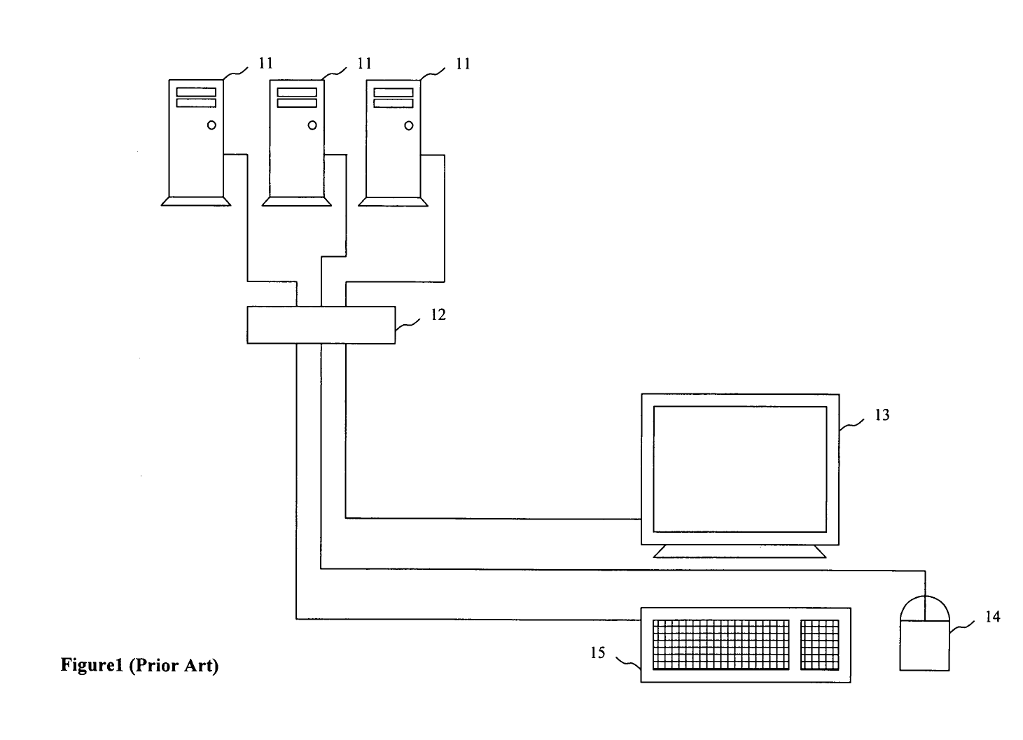

FIG. 2 shows the block diagram of the full functional computer peripheral converter according to the present invention.

FIG. 3 shows the detailed structure diagram of the core of the computer peripheral converter according to the present invention.

### DETAILED DESCRIPTION OF THE PREFERRED EMBODIMENT

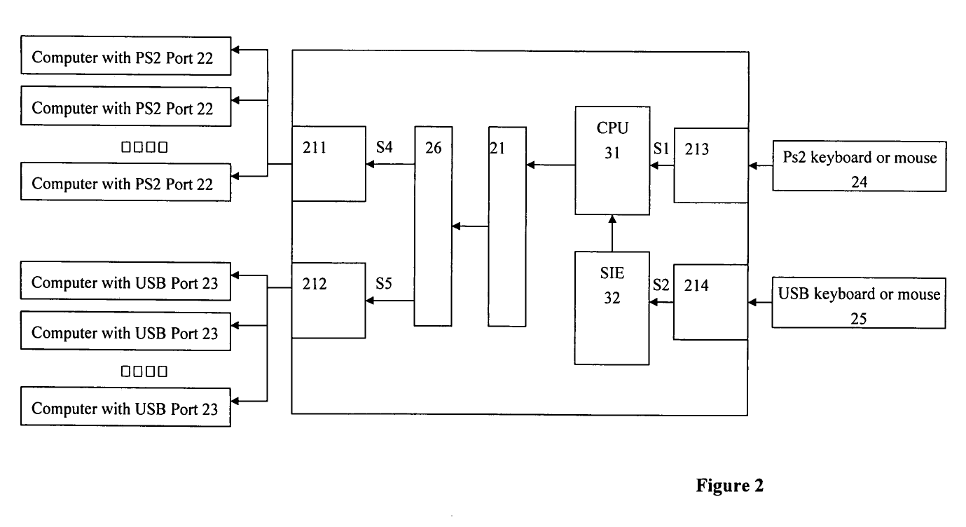

FIG. 2 shows the block diagram of the full functional computer peripheral converter according to the present invention. Computer platform 21 connects with the CPU 31. CPU 31 comprises one PS2 connecting point to receive PS2 signal S1; serial interface engine 32 connects with the CPU 31 that comprises a USB connecting point to receive USB signal S2. PS2 socket 211, USB socket 212, PS2 socket 213, and USB socket 214, computer 22 with PS2 port, computer 23 with USB port, PS2 keyboard or mouse 24, and USB keyboard or mouse 25, and PS2/USB interface 26 are all shown in the FIG. 2.

The computer peripheral converter of the present invention (that comprises the CPU 31 and serial interface engine 32 at least) will be able to output PS2 signal S4 and USB signal S5 after integrating with the computer platform switch 21 and PS2/USB interface 26, to make end users to connect all types of computer and peripherals as they like. Therefore, the end users will never mention about the port specification of their computers are PS2 port only, USB port only, or both of PS2 port and USB port; and never mention about the port specification of their peripherals are PS2 keyboard, PS2 mouse, USB keyboard, or USB mouse. The end users are able to control multiple computers by single peripheral via connecting all computers and peripherals with the full functional computer peripheral converter as FIG. 2.

In other words, FIG. 2 is a total solution to integrate all the possible switching modes in one device between the USB host, PS2 host, USB mouse, and PS2 mouse, to make the multiple computers controlled by single peripheral very easily of these two above specifications of computers and peripherals.

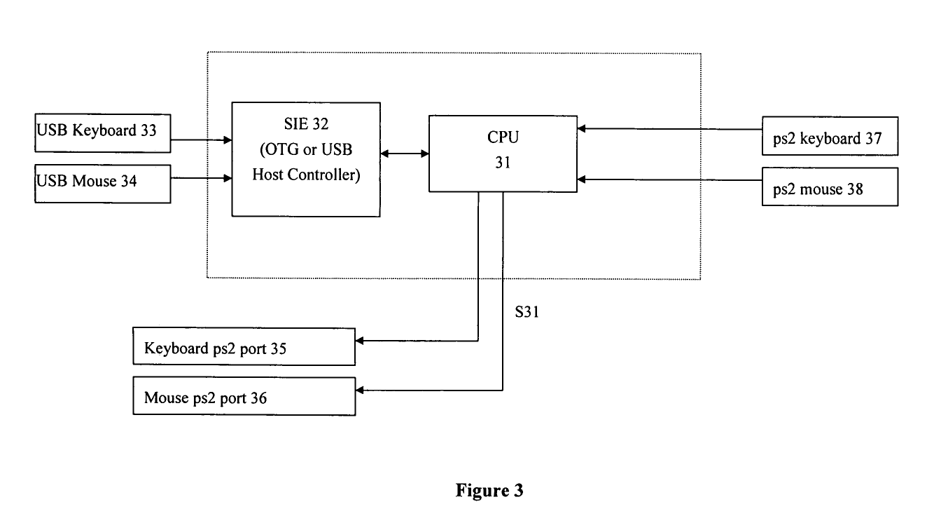

FIG. 3 shows the detailed structure diagram of the core of the computer peripheral converter according to the present invention. In FIG. 3, the main components are CPU 31 and serial interface engine (SIE) 32 (which could be an OTG or USB host controller), the input could be connecting with the USB keyboard 33, USB mouse 34, PS2 keyboard 37, or PS2 mouse 38; the output S31 could be connecting with the PS2 keyboard port 35 and PS2 mouse port 36 of the computer, or an external interface signal (such as PS2, I2C, SPI (Serial Peripheral Interface), URT, or self-defined interface signal) to connect with a PS2/USB interface. Of course, the computer peripheral converter of the present invention also can be integrated by any type of ASIC, FPGA, or two CPUs. The CPU 31 will connect with the ROM or RAM usually. CPU 31 will detect whether the output side connects with the PS2 keyboard 37 and PS2 mouse 38, or USB keyboard 33 and USB mouse 34 or not. If the detecting result is USB peripherals with PS2 computer, this computer peripheral converter according to the present invention will convert the USB signal to PS2 signal automatically; if the detecting result is PS2 peripherals with PS2 computer, this computer peripheral converter according to the present invention will only need to switch to connect the signals.

Of course, the computer peripheral converter of the present invention also can support hot key, that is, the USB keyboard or PS2keyboard that connects with the computer peripheral converter according to the present invention is able to execute the special function of the computer peripheral converter by pressing hot keys, such as switching to control different computers by pressing hot keys. Under the structure of FIG. 3, there is no need for any device driver or O.S. support of the USB keyboard or mouse, that is, all the related driver or technical support will be solved by hardware or firmware of the computer peripheral converter according to the present invention internally.

The computer peripheral converter according to the present invention is able to connect with the host computer alone to let end users use any type of USB or PS2 mouse or keyboard. The computer peripheral converter according to the present invention will become a combo free KVM to support any USB and PS2 switching mode when it integrates with a PS2/USB interface (as FIG. 2). Therefore, the present invention can guarantee the PS2 peripherals or USB peripherals of the end users would be still used.

To sum up, the computer peripheral converter of the present invention is a newly advantaged design for solving the disadvantages of the traditional technology, that is able to connect with host computer alone, support the connections between USB and PS2 peripherals and PS2/USB computers, and also integrate with PS2/USB interfaces to solve all possible switching modes of PS2 and USB. The computer peripheral converter according to the present invention is also a full functional combo free KVM to support any switch type between USB and PS2 interfaces to reduce the cost of space and peripheral equipments.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims that are to be accorded with the broadest interpretation so as to encompass all such modifications and similar structures.

What claims is:

1. A computer peripheral converter, at least comprising a PS2 connecting point, a USB connecting point and an external connecting point, and further having a CPU and a serial interface engine for converting said PS2 connecting point to said external connecting point and send out an external interface signal; and to convert said USB connecting point to said external connecting point and send out said external interface signal.

2. The converter according to claim 1 wherein said external connecting point comprises two PS2 connecting sockets for connecting with a keyboard PS2 port and a mouse PS2 port of a computer.

3. The converter according to claim 1 wherein said PS2 connecting point comprises two PS2 sockets for connecting with one PS2 keyboard and one PS2 mouse.

4. The converter according to claim 1 wherein said USB connecting point comprises two USB sockets for connecting with one USB keyboard and one USB mouse.

5. The converter according to claim 4 wherein said external connecting point connects with a PS2/USB interface, to make one of said PS2 keyboard or said USB keyboard, and one of said PS2 mouse or said USB mouse to control several computers.

6. The converter according to claim 5 wherein said several computers have PS2 ports or USB ports.

7. The converter according to claim 1 wherein said external interface signal is a PS2, I2C, SPI (Serial Peripheral Interface), UART, or self-defined interface signal.
